(19) United States
(12) Patent Application Publication
(10) Pub. No.: US 2026/0323180 A1
(43) Pub. Date: Oct. 15, 2026

(54) SOLID-STATE IMAGE SENSOR, DISTANCE IMAGING APPARATUS, AND DISTANCE MEASURING METHOD

(71) Applicant: Nuvoton Technology Corporation Japan, Kyoto (JP)

(72) Inventors: Yasuhiro KOSAKA, Kyoto (JP); Takahiro MUROSHIMA, Kyoto (JP)

(21) Appl. No.: 19/696,864

(22) Filed: Jun. 3, 2026

Related U.S. Application Data
(63) Continuation of application No. PCT/JP2024/043802, filed on Dec. 11, 2024.
(60) Provisional application No. 63/609,653, filed on Dec. 13, 2023.

(51) Int. Cl. H04N 25/704; G01S 7/4914; G01S 7/4915

(52) U.S. Cl. CPC H04N 25/704; G01S 7/4914; G01S 7/4915

(57) ABSTRACT

A solid-state image sensor includes a pixel array in which a plurality of pixels including first pixels and second pixels are arranged two-dimensionally. Each of the first pixels is based on an exposure signal that is synchronized with a light emission signal, to generate a distance detection signal. Each of the second pixels generates a phase difference detection signal based on light incident from pupil-divided regions of the reflected light. The pixel array includes one or more phase difference detection areas in each of which two or more second pixels are aligned in one direction. Within the pixel array, one or more first pixels are each disposed at a location that differs from each location of the one or more phase difference detection areas and that is closer to the center of the pixel array than at least one phase difference detection area is.

### CROSS REFERENCE TO RELATED APPLICATIONS

This is a continuation application of PCT International Patent Application No. PCT/JP2024/043802 filed on Dec. 11, 2024, designating the United States of America, which is based on and claims priority of U.S. Provisional Patent Application No. 63/609,653 filed on Dec. 13, 2023. The entire disclosures of the above-identified applications, including the specifications, drawings and claims are incorporated herein by reference in their entirety.

### FIELD

The present disclosure relates to a solid-state image sensor, a distance imaging apparatus, and a distance measuring method.

### BACKGROUND

Patent Literature (PTL) 1 discloses a technique for correcting an error included in a distance image obtained by image capturing using a time-of-flight (TOF) camera.

### CITATION LIST

### Patent Literature

PTL 1: Japanese Unexamined Patent Application Publication No. 2020-008531

### SUMMARY

### Technical Problem

For example, in the technique disclosed in PTL 1, a correction amount is calculated by comparing (i) a distance value to a reference object, which is calculated based on a two-dimensional image obtained by capturing the reference object having a plurality of feature points with clear three-dimensional coordinate correlations, with (ii) a distance measurement value obtained by a distance imaging apparatus, and the distance measurement value is corrected.

However, the technique disclosed in PTL 1 has an issue in that it requires a reference object and is inconvenient in situations where correction needs to be repeated, such as when the surrounding environment is prone to change.

In view of this, the present disclosure provides, for example, a solid-state image sensor usable in a distance measuring apparatus that can easily correct a distance measurement value.

### Solution to Problem

A solid-state image sensor according to one aspect of the present disclosure includes: a pixel array in which a plurality of pixels including first pixels and second pixels are arranged two-dimensionally, in which each of the first pixels is exposed to reflected light of irradiation light from a target object, based on an exposure signal that is synchronized with a light emission signal, to generate a distance detection signal, each of the second pixels generates a phase difference detection signal based on light incident from pupil-divided regions of the reflected light, the pixel array includes one or more phase difference detection areas in each of which two or more second pixels among the second pixels are aligned in one direction, and within the pixel array, one or more first pixels among the first pixels are each disposed at a location that differs from each location of the one or more phase difference detection areas and that is closer to a center of the pixel array than at least one phase difference detection area of the one or more phase difference detection areas is.

Moreover, a distance imaging apparatus according to one aspect of the present disclosure includes: the above solid-state image sensor; a light source that irradiates a target object with the irradiation light; a distance calculator that calculates a first distance to the target object based on the distance detection signals generated by the first pixels; a drive controller that outputs (i) the light emission signal that instructs the light source to emit the irradiation light and (ii) the exposure signal that instructs the solid-state image sensor to expose the plurality of pixels; and a correction processor that calculates a second distance to the target object based on the phase difference detection signals generated by the second pixels, and performs processing for correcting the first distance based on the first distance and the second distance.

Moreover, a distance imaging apparatus according to another aspect of the present disclosure includes: a solid-state image sensor including a pixel array in which a plurality of pixels including first pixels and second pixels are arranged two-dimensionally; a light source that irradiates a target object with irradiation light; a distance calculator; a drive controller; and a correction processor, in which each of the first pixels is exposed to reflected light of the irradiation light from the target object, based on an exposure signal that is synchronized with a light emission signal, to generate a distance detection signal, each of the second pixels generates a phase difference detection signal based on light incident from pupil-divided regions of the reflected light, the distance calculator calculates a first distance to the target object based on the distance detection signals generated by the first pixels, the drive controller outputs the light emission signal to the light source and the exposure signal to the solid-state image sensor, and the correction processor calculates a second distance to the target object based on the phase difference detection signals generated by the second pixels, and performs processing for correcting the first distance based on the first distance and the second distance.

Moreover, a distance measuring method according to one aspect of the present disclosure is a distance measuring method using the above solid-state image sensor, the distance measuring method including: outputting the light emission signal to a light source that irradiates the target object with the irradiation light and the exposure signal to the solid-state image sensor; obtaining the distance detection signals from the solid-state image sensor, and calculating a first distance to the target object based on the distance detection signals; and calculating a second distance to the target object based on the phase difference detection signals generated by the second pixels, and performing processing for correcting the first distance based on the first distance and the second distance.

Moreover, a distance measuring method according to another aspect of the present disclosure is a distance measuring method performed by a distance imaging apparatus, the distance imaging apparatus including: a light source that irradiates a target object with irradiation light; and a solid-state image sensor including a pixel array in which a plurality of pixels including first pixels and second pixels are arranged two-dimensionally, in which each of the first pixels is exposed to reflected light of the irradiation light from the target object, based on an exposure signal that is synchronized with a light emission signal, to generate a distance detection signal, and each of the second pixels generates a phase difference detection signal based on light incident from pupil-divided regions of the reflected light. The distance measuring method includes: outputting the light emission signal to the light source and the exposure signal to the solid-state image sensor; calculating a first distance to the target object based on the distance detection signals generated by the first pixels; and calculating a second distance to the target object based on the phase difference detection signals generated by the second pixels, and performing processing for correcting the first distance based on the first distance and the second distance.

It should be noted that the present disclosure can be implemented not only as the above distance measuring method but also as a program for causing a computer to execute the above distance measuring method. Furthermore, the present disclosure can be implemented as a computer-readable recording medium in which the program is stored.

### Advantageous Effects

A solid-state image sensor, a distance imaging apparatus, and a distance measuring method according to the present disclosure can be used in a distance measuring apparatus capable of easily correct a distance measurement value.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a functional configuration of a distance imaging apparatus according to an embodiment.

FIG. 2 is a block diagram illustrating a functional configuration of a solid-state image sensor according to the embodiment.

FIG. 3 is a circuit diagram illustrating an example of a circuit configuration of a pixel according to the embodiment.

FIG. 4 illustrates an example of pixel arrangement in a pixel array according to the embodiment.

FIG. 5 illustrates a situation where the distance imaging apparatus according to the embodiment is used as an endoscopy system.

FIG. 6 is a flowchart illustrating an operation of the distance imaging apparatus according to the embodiment.

FIG. 7 illustrates parallax detection by phase difference pixels.

FIG. 8 is a timing chart illustrating an imaging operation of the distance imaging apparatus according to the embodiment that is performed prior to correction.

FIG. 9 illustrates a relationship between parallax and a phase difference.

FIG. 10 is a timing chart illustrating an imaging operation of the distance imaging apparatus according to the embodiment that is performed after the correction.

FIG. 11 illustrates a first example of pixel arrangement in the pixel array according to the embodiment.

FIG. 12 illustrates a second example of pixel arrangement in the pixel array according to the embodiment.

FIG. 13 illustrates a third example of pixel arrangement in the pixel array according to the embodiment.

FIG. 14 illustrates a fourth example of pixel arrangement in the pixel array according to the embodiment.

FIG. 15 illustrates a fifth example of pixel arrangement in the pixel array according to the embodiment.

FIG. 16 illustrates a sixth example of pixel arrangement in the pixel array according to the embodiment.

FIG. 17 illustrates a seventh example of pixel arrangement in the pixel array according to the embodiment.

FIG. 18 illustrates an eighth example of pixel arrangement in the pixel array according to the embodiment.

### DESCRIPTION OF EMBODIMENT

### (Knowledge Obtained by Inventors)

In a time-of-flight (TOF) distance measuring sensor, the distance to a subject is calculated from the exposure amount of reflected light. In this case, to calculate an accurate distance, the phase of an irradiation pulse of light emitted to the subject must be matched with that of an exposure pulse used for the exposure to the reflected light.

Here, when a control circuit and a light source are positioned apart from a TOF sensor that performs exposure, as in an endoscope or the like, a phase difference occurs between the irradiation pulse and the exposure pulse due to a propagation delay. Accordingly, it is necessary to perform a correction to match the phase of the irradiation pulse with that of the exposure pulse in consideration of the phase difference caused by the propagation delay.

However, since the phase difference caused by the propagation delay changes depending on the usage environment of the distance imaging apparatus, such as the temperature or the shape of a cable through which the pulses propagate, adjustment at the time of shipment alone is insufficient; therefore, the phase difference must be detected and corrected during use.

Here, by providing an optical path that allows the irradiation pulse to be incident directly onto the TOF sensor that performs exposure at a cable end portion, and measuring the distance by the TOF sensor, the distance measurement value to an object can be corrected using the distance measurement value obtained by the distance measurement. In this case, the size of the cable end portion is large. The large size of the cable end portion is disadvantageous for endoscope apparatuses.

In view of this, the inventors have conceived of arranging phase difference pixels in a TOF sensor. By detecting parallax using the phase difference pixels, the distance to a subject can be calculated without being affected by a propagation delay of a cable or the like. Accordingly, by correcting the TOF distance measurement value based on the distance measurement value obtained using the phase difference pixels, it becomes possible to calculate an accurate distance using the TOF method.

### (Overview of the Present Disclosure)

A solid-state image sensor according to a first aspect of the present disclosure includes: a pixel array in which a plurality of pixels including first pixels and second pixels are arranged two-dimensionally, in which each of the first pixels is exposed to reflected light of irradiation light from a target object, based on an exposure signal that is synchronized with a light emission signal, to generate a distance detection signal, each of the second pixels generates a phase difference detection signal based on light incident from pupil-divided regions of the reflected light, the pixel array includes one or more phase difference detection areas in each of which two or more second pixels among the second pixels are aligned in one direction, and within the pixel array, one or more first pixels among the first pixels are each disposed at a location that differs from each location of the one or more phase difference detection areas and that is closer to a center of the pixel array than at least one phase difference detection area of the one or more phase difference detection areas is.

Such a solid-state image sensor includes a pixel array including TOF pixels that perform TOF distance measurement and phase difference pixels that perform distance measurement by performing phase difference detection, which enables distance detection using the two methods. Accordingly, such a solid-state image sensor can be used in a distance measuring apparatus capable of easily correcting a distance measurement value.

A solid-state image sensor according to a second aspect of the present disclosure is the solid-state image sensor according to the first aspect in which a total number of the first pixels is greater than a total number of the second pixels.

Such a solid-state image sensor can generate a TOF image with a higher resolution.

A solid-state image sensor according to a third aspect of the present disclosure is the solid-state image sensor according to the first or second aspect in which the first pixels have a mode for generating a visible light image signal.

Such a solid-state image sensor can change the distance measurement range when capturing a TOF image.

A solid-state image sensor according to a fourth aspect of the present disclosure is the solid-state image sensor according to any one of the first to third aspects in which the one or more phase difference detection areas include a first phase difference detection area in which the two or more second pixels are aligned in a first direction and a second phase difference detection area in which the two or more second pixels are aligned in a second direction orthogonal to the first direction, and the two or more second pixels aligned in the first phase difference detection area receive light incident from pupil-divided regions in the first direction, and the two or more second pixels aligned in the second phase difference detection area receive light incident from pupil-divided regions in the second direction.

Such a solid-state image sensor can perform phase difference detection in two orthogonal directions. In typical phase difference detection, a phase difference may not be detected depending on the direction of detection. Accordingly, such a solid-state image sensor can improve the efficiency of phase difference detection.

A solid-state image sensor according to a fifth aspect of the present disclosure is the solid-state image sensor according to any one of the first to fourth aspects in which a size of each of the second pixels differs from a size of each of the first pixels.

Such a solid-state image sensor can adjust the resolution of a TOF image and the phase difference detection pixels without changing the chip size.

A solid-state image sensor according to a sixth aspect of the present disclosure is the solid-state image sensor according to any one of the first to fifth aspects in which the pixel array includes an effective pixel area in which some of the first pixels are arranged two-dimensionally, and the one or more phase difference detection areas are disposed outside the effective pixel area

Such a solid-state image sensor can avoid degradation of a TOF image obtained in the effective pixel area. Moreover, the arrangement where phase difference detection area 220 is disposed outside effective pixel area 210 makes it easier to change the pixel size of the second pixels included in phase difference detection area 220 and control the second pixels.

A solid-state image sensor according to a seventh aspect of the present disclosure is the solid-state image sensor according to any one of the first to fifth aspects in which the pixel array includes an effective pixel area in which some of the first pixels are arranged two-dimensionally, and the one or more phase difference detection areas are disposed inside the effective pixel area.

Such a solid-state image sensor can reduce the chip size of the entire pixel array.

A solid-state image sensor according to an eighth aspect of the present disclosure is the solid-state image sensor according to any one of the first to fifth aspects in which the pixel array includes an effective pixel area in which some of the first pixels are arranged two-dimensionally, and the one or more phase difference detection areas include a phase difference detection area disposed outside the effective pixel area and a phase difference detection area disposed inside the effective pixel area.

Such a solid-state image sensor can reduce the chip size of the entire pixel array while avoiding the degradation of a TOF image obtained in the effective pixel area.

A solid-state image sensor according to a ninth aspect of the present disclosure is the solid-state image sensor according to any one of the first to fifth aspects in which the pixel array includes an effective pixel area in which some of the first pixels are arranged two-dimensionally, and the one or more phase difference detection areas are each disposed along a side of the effective pixel area.

Such a solid-state image sensor can avoid the degradation of a TOF image obtained in the effective pixel area since no phase difference detection areas are present in the center of the effective pixel area.

A solid-state image sensor according to a tenth aspect of the present disclosure is the solid-state image sensor according to any one of the first to fifth aspects in which the one or more phase difference detection areas are a plurality of phase difference detection areas arranged in a predetermined direction.

Since such a solid-state image sensor can decrease the distances between the TOF pixels and the phase difference pixels, it is possible to bring a distance value obtained by the TOF pixels and a distance value obtained by the phase difference pixels closer to each other.

A solid-state image sensor according to an eleventh aspect of the present disclosure is the solid-state image sensor according to any one of the first to fifth aspects in which the one or more phase difference detection areas include a phase difference detection area in which the two or more second pixels are aligned in a first direction and a phase difference detection area in which the two or more second pixels are aligned in a second direction orthogonal to the first direction.

Such a solid-state image sensor can perform phase difference detection in two orthogonal directions.

A distance imaging apparatus according to a twelfth aspect of the present disclosure includes: the solid-state image sensor according to any one of the first to eleventh aspects; a light source that irradiates a target object with the irradiation light; a distance calculator that calculates a first distance to the target object based on the distance detection signals generated by the first pixels; a drive controller that outputs (i) the light emission signal that instructs the light source to emit the irradiation light and (ii) the exposure signal that instructs the solid-state image sensor to expose the plurality of pixels; and a correction processor that calculates a second distance to the target object based on the phase difference detection signals generated by the second pixels, and performs processing for correcting the first distance based on the first distance and the second distance.

Based on the second distance calculated based on the phase difference detection signals generated by the phase difference pixels, such a distance imaging apparatus can correct the first distance calculated based on the distance detection signals generated by the TOF pixels. Such a distance imaging apparatus can easily correct the distance measurement value even if a time difference occurs between the irradiation timing and the exposure timing, such as in cases where the distance imaging apparatus is used in an endoscopy system.

A distance imaging apparatus according to a thirteenth aspect of the present disclosure is the distance imaging apparatus according to the twelfth aspect in which the correction processor adjusts timings at which the drive controller outputs the light emission signal and the exposure signal, to correct a difference between the first distance and the second distance

Such a distance imaging apparatus can correct the distance measurement value by adjusting the timing at which the drive controller instructs driving, so that a correct distance image can be output through the correction. Accordingly, it is possible to contribute to a reduction in the number of processes performed after the generation of the distance image.

A distance imaging apparatus according to a fourteenth aspect of the present disclosure is the distance imaging apparatus according to the twelfth aspect in which the correction processor corrects a value of the first distance based on a difference between the first distance and the second distance.

In such a distance imaging apparatus, the correction processor can correct the distance measurement value by calculating a difference between the first distance and the second distance and subtracting the difference. Accordingly, such a distance imaging apparatus can perform the correction through processing after the generation of the distance image, without changing the driving timing.

A distance imaging apparatus according to a fifteenth aspect of the present disclosure is the distance imaging apparatus according to any one of the twelfth to fourteenth aspects in which the correction processor performs the processing for correcting the first distance when the reflected light incident on the one or more phase difference detection areas has contrast variations.

By automatically calculating the second distance when it is possible to calculate the second distance, such a distance imaging apparatus can easily maintain the corrected state in situations where the environment changes rapidly.

A distance imaging apparatus according to a sixteenth aspect of the present disclosure includes: a solid-state image sensor including a pixel array in which a plurality of pixels including first pixels and second pixels are arranged two-dimensionally; a light source that irradiates a target object with irradiation light; a distance calculator; a drive controller; and a correction processor, in which each of the first pixels is exposed to reflected light of the irradiation light from the target object, based on an exposure signal that is synchronized with a light emission signal, to generate a distance detection signal, each of the second pixels generates a phase difference detection signal based on light incident from pupil-divided regions of the reflected light, the distance calculator calculates a first distance to the target object based on the distance detection signals generated by the first pixels, the drive controller outputs the light emission signal to the light source and the exposure signal to the solid-state image sensor, and the correction processor calculates a second distance to the target object based on the phase difference detection signals generated by the second pixels, and performs processing for correcting the first distance based on the first distance and the second distance.

Based on the second distance calculated based on the phase difference detection signals generated by the phase difference pixels, such a distance imaging apparatus can correct the first distance calculated based on the distance detection signals generated by the TOF pixels. Such a distance imaging apparatus can easily correct a distance measurement value even if a time difference occurs between the irradiation timing and the exposure timing, such as in cases where the distance imaging apparatus is used in an endoscopy system.

A distance measuring method according to a seventeenth aspect of the present disclosure is a distance measuring method using the solid-state image sensor according to any one of the first to eleventh aspects, the distance measuring method including: outputting the light emission signal to a light source that irradiates the target object with the irradiation light and the exposure signal to the solid-state image sensor; obtaining the distance detection signals from the solid-state image sensor, and calculating a first distance to the target object based on the distance detection signals; and calculating a second distance to the target object based on the phase difference detection signals generated by the second pixels, and performing processing for correcting the first distance based on the first distance and the second distance.

In such a distance measuring method, the first distance calculated based on the distance detection signals generated by the TOF pixels can be corrected based on the second distance calculated based on the phase difference detection signals generated by the phase difference pixels. Such a distance measuring method can easily correct a distance measurement value even if a time difference occurs between the irradiation timing and the exposure timing, such as in cases where the distance imaging apparatus is used in an endoscopy system.

A distance measuring method according to an eighteenth aspect of the present disclosure is a distance measuring method performed by a distance imaging apparatus, the distance imaging apparatus including: a light source that irradiates a target object with irradiation light; and a solid-state image sensor including a pixel array in which a plurality of pixels including first pixels and second pixels are arranged two-dimensionally, in which each of the first pixels is exposed to reflected light of the irradiation light from the target object, based on an exposure signal that is synchronized with a light emission signal, to generate a distance detection signal, and each of the second pixels generates a phase difference detection signal based on light incident from pupil-divided regions of the reflected light. The distance measuring method includes: outputting the light emission signal to the light source and the exposure signal to the solid-state image sensor; calculating a first distance to the target object based on the distance detection signals generated by the first pixels; and calculating a second distance to the target object based on the phase difference detection signals generated by the second pixels, and performing processing for correcting the first distance based on the first distance and the second distance.

In such a distance measuring method, the first distance calculated based on the distance detection signals generated by the TOF pixels can be corrected based on the second distance calculated based on the phase difference detection signals generated by the phase difference pixels. Such a distance measuring method can easily correct a distance measurement value even if a time difference occurs between the irradiation timing and the exposure timing, such as in cases where the distance imaging apparatus is used in an endoscopy system.

Hereinafter, an embodiment in the present disclosure is described in detail with reference to the drawings.

It should be noted that the embodiment described below indicates a comprehensive or specific example. The numerical values, shapes, elements, arrangement and connection of the elements, steps, order of steps, and so forth indicated in the embodiment described below are merely examples, and do not intend to limit the present disclosure. Moreover, among the elements described in the embodiment below, those not recited in the independent claims are described as optional elements. Moreover, the figures are schematic illustrations and are not necessarily precise depictions. Moreover, in the figures, substantially the same elements are assigned the same reference signs, and overlapping explanations are omitted or simplified.

Moreover, in the specification, terms indicating relationships between elements, such as vertical, horizontal, or matching, terms describing the shapes of elements, such as circular or rectangular, and numerical ranges should not be construed as limited to their strict interpretation. Rather, they are intended to encompass substantially equivalent ranges, including variations of, for example, approximately a few percent.

Moreover, in this specification, ordinal numbers such as “first” and “second” are used for the purpose of distinguishing between similar elements to avoid confusion, and do not indicate the quantity or order of the elements unless explicitly stated otherwise.

Moreover, in the specification, “correction” between elements means electrical connection unless otherwise noted.

### Embodiment

### [Configuration]

First, a configuration of a distance imaging apparatus according to an embodiment is described. The distance imaging apparatus according to the embodiment is used in, for example, an endoscopy system.

### [Distance Imaging Apparatus]

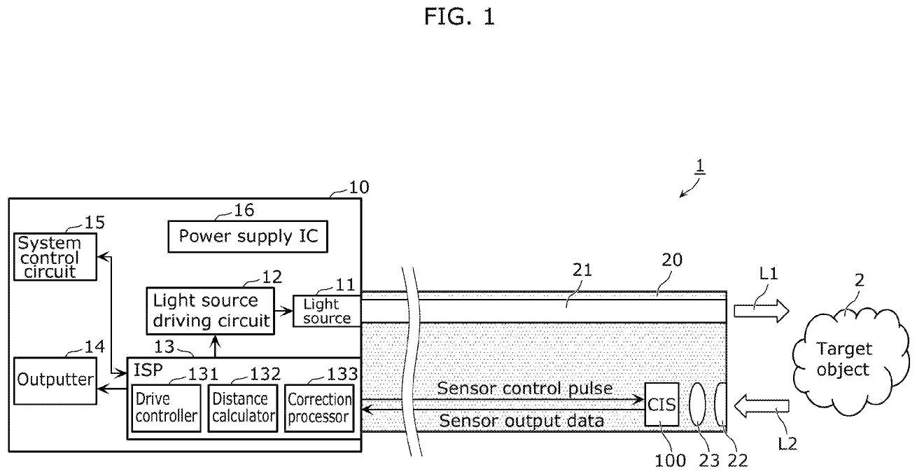

First, the distance imaging apparatus according to the embodiment is described with reference to FIG. 1. FIG. 1 is a block diagram illustrating a functional configuration of distance imaging apparatus 1 according to the embodiment.

Distance imaging apparatus 1 is an example of a distance imaging apparatus. As illustrated in FIG. 1, distance imaging apparatus 1 can measure the distance to target object 2 by irradiating target object 2 with irradiation light L1 and receiving reflected light L2 of irradiation light L1 from target object 2. Moreover, distance imaging apparatus 1 may obtain a visible light image of target object 2.

As illustrated in FIG. 1, distance imaging apparatus 1 includes main body 10 and insertion section 20. Distance imaging apparatus 1 is used by inserting insertion section 20 into the body of, for example, a person or an animal. That is, target object 2 is part of the body.

Main body 10 is a portion of distance imaging apparatus 1 not intended to be inserted into the body. As illustrated in FIG. 1, main body 10 includes light source 11, light source driving circuit 12, image signal processor (ISP) 13, outputter 14, system control circuit 15, and power supply integrated circuit (IC) 16.

Light source 11 emits irradiation light for target object 2. Specifically, light source 11 can emit flashing light of a predetermined wavelength for distance measurement. The predetermined wavelength is included in, for example, a visible light range. The visible light range is, for example, a wavelength range from 380 nm to 780 nm, inclusive. The flashing light is light that periodically transitions between bright and dark. The flashing rate of the light is, for example, at least 1 MHz and at most 200 MHz, and as a non-limiting example, the flashing rate of the light is 50 MHz. Light source 11 is implemented as, for example, a light-emitting diode (LED), a semiconductor laser device, or an organic electroluminescence (EL) device. As an example, light source 11 includes a blue LED or a blue laser device that emits blue light, and a yellow phosphor that emits yellow light as a result of being excited by blue light, and light source 11 emits white light as a mixture of blue light and yellow light. It should be noted that the predetermined wavelength of the light emitted by light source 11 is included in a near-infrared range, and light source 11 may be implemented as a near-infrared laser device that emits near-infrared light as flashing light. Moreover, light source 11 may emit non-flashing light, which is not flashing light.

Light source driving circuit 12 is a circuit that drives light source 11. Specifically, light source driving circuit 12 controls turn-on and turn-off timings of light source 11. For instance, light source driving circuit 12 controls turn-on and turn-off timings of light source 11, based on an emission control pulse obtained from ISP 13. Light source driving circuit 12 can control turn-on and turn-off timings of light source 11 by adjusting the start and stop timings of power supply to light source 11.

Light source driving circuit 12 is formed by combining one or more components from various electronic components, such as an IC, a resistor, a transistor, a diode, a capacitor, an inductor, and a transformer. Light source driving circuit 12 and other elements, such as power supply IC 16 or system control circuit 15, may be integrated.

ISP 13 is an example of a computation circuit, and processes a signal output by solid-state image sensor 100, that is, sensor output data. ISP 13 calculates the distance to target object 2 using the sensor output data. ISP 13 generates a distance image indicating the distance to target object 2 for each pixel. Although the distance image is a still image, it may be a moving image (video). ISP 13 may generate a visible light image based on the sensor output data. The visible light image is, for example, an RGB image, and an image including the respective luminance values of RGB. Specifically, ISP 13 includes drive controller 131, distance calculator 132, and correction processor 133.

Drive controller 131 outputs an emission control pulse to light source driving circuit 12. The emission control pulse is an example of a light emission signal. The emission control pulse is a signal that instructs light source 11 on the irradiation timing. Moreover, drive controller 131 outputs a sensor control pulse to solid-state image sensor 100. The sensor control pulse is an example of an exposure signal. The sensor control pulse is a signal that instructs solid-state image sensor 100 on the exposure timing.

Distance calculator 132 calculates the distance value to target object 2 based on distance detection signals generated by a plurality of TOF pixels. A TOF pixel is an example of a first pixel. The distance value to target object 2 calculated based on the distance detection signals is an example of a first distance.

Correction processor 133 calculates the distance value to target object 2 based on phase difference detection signals generated by a plurality of phase difference pixels. Furthermore, correction processor 133 performs processing for correcting the distance value to target object 2 calculated based on the distance detection signals, based on (i) the distance value to target object 2 calculated based on the distance detection signals by distance calculator 132 and (ii) the distance value to target object 2 calculated based on the phase difference detection signals by correction processor 133. A phase difference pixel is an example of a second pixel. The distance value to target object 2 calculated based on the phase difference detection signals is an example of a second distance.

Outputter 14 outputs a distance image generated by ISP 13. For instance, outputter 14 is a communication interface (IF) for performing wired or wireless communication with an external device, such as a display. For instance, outputter 14 is an output terminal to which a communication cable can be connected. Alternatively, outputter 14 may include an antenna and a wireless processing circuit.

System control circuit 15 performs overall control of distance imaging apparatus 1. Specifically, system control circuit 15 instructs distance imaging apparatus 1 to perform distance measurement and correction of a distance measurement value. For instance, system control circuit 15 is implemented as a large scale integration (LSI), which is an integrated circuit. It should be noted that the integrated circuit is not limited to an LSI and may be a dedicated circuit or a general-purpose processor. For instance, system control circuit 15 may be a microcontroller. The microcontroller includes, for example, nonvolatile memory in which a program is stored, volatile memory that is a temporary storage area in which to execute the program, an input/output port, and a processor that executes the program. Moreover, system control circuit 15 may be a field programmable gate array (FPGA) that can be programmed or a reconfigurable processor that can reconfigure the connection and settings of circuit cells within an LSI. Functions executed by system control circuit 15 may be implemented by software or hardware.

Power supply IC 16 is a power supply circuit that processes the power supplied from an external power supply, such as a commercial power supply or a storage battery device. For instance, power supply IC 16 includes an AC/DC converter and/or a DC/DC converter.

Although not illustrated in FIG. 1, distance imaging apparatus 1 may include an operator that receives an operation input from a user. The operator may be a physical operation button or a physical operation switch and may be a touch panel or the like. The operator may be a communication IF that receives an operation input via a remote operation terminal, such as a remote controller.

Insertion section 20 is a flexible part, and at least an end portion (end portion opposite main body 10) of insertion section 20 is inserted into the body when distance imaging apparatus 1 is used. For instance, when target object 2 is an upper or lower gastrointestinal (GI) tract, the length of insertion section 20 ranges from 1 m to 2 m, inclusive. It should be noted that the length of insertion section 20 is not particularly limited. As illustrated in FIG. 1, insertion section 20 includes light guide member 21, object lens 22, condenser lens 23, and solid-state image sensor (contact image sensor (CIS)) 100.

Light guide member 21 guides the light emitted by light source 11 to the end portion, and enables emission of the light from the end portion toward target object 2 as irradiation light L1. As a non-limiting example, light guide member 21 is an optical fiber.

Object lens 22 and condenser lens 23 are optical systems for causing solid-state image sensor 100 to receive reflected light L2 from target object 2. If it is possible to make solid-state image sensor 100 receive reflected light L2, the types and the number of lenses are not particularly limited. Moreover, optical elements other than the lenses may be provided.

Solid-state image sensor 100 outputs an image signal obtained by photoelectrically converting reflected light L2 from target object 2. Specifically, solid-state image sensor 100 performs exposure at the timing based on the sensor control pulse obtained from ISP 13, and generates an image signal. Solid-state image sensor 100 outputs the image signal to ISP 13 as the sensor output data.

Solid-state image sensor 100 is connected to ISP 13 via one or more cables (not illustrated). Solid-state image sensor 100 operates based on the sensor control pulse transmitted from ISP 13 via the one or more cables. The sensor control pulse is, for example, master clock MCLK or vertical synchronizing signal VD. Moreover, in the embodiment, solid-state image sensor 100 is a complementary metal-oxide-semiconductor (CMOS) image sensor (CIS). Solid-state image sensor 100 is, for example, a backside-illuminated CIS.

### [Solid-State Image Sensor]

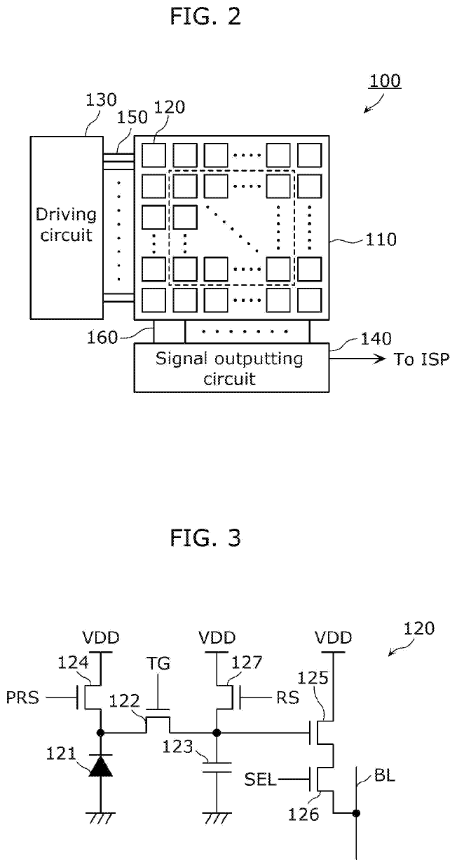

Next, a specific configuration of solid-state image sensor 100 is described with reference to FIG. 2. FIG. 2 is a block diagram illustrating a functional configuration of solid-state image sensor 100 according to the embodiment.

As illustrated in FIG. 2, solid-state image sensor 100 includes pixel array 110, driving circuit 130, and signal outputting circuit 140. Moreover, solid-state image sensor 100 includes control lines 150, power supply lines (not illustrated), and vertical signal lines 160.

Pixel array 110 includes pixels 120 arranged in a matrix, that is, in a two-dimensional array. Pixels 120 include first pixels and second pixels. Based on the sensor control pulse that is synchronized with the emission control pulse, each of the first pixels is exposed to reflected light L2 of irradiation light L1 from target object 2, to generate a distance detection signal. Each of the second pixels generates a phase difference detection signal based on the light incident from pupil-divided regions of reflected light L2. As a non-limiting example of the number of pixels 120, there are at least several hundred pixels or at least several thousand pixels both in a row direction and in a column direction. Details of pixels 120 are described later. Moreover, each of the first pixels may generate a visible light image signal.

It should be noted that in FIG. 2, the area surrounded by the dashed line within pixel array 110 is an effective pixel area. The effective pixel area is an area in which to generate a TOF image using the first pixels. Pixels also referred to as, for example, dummy pixels are disposed around the effective pixel area in FIG. 2. It should be noted that the dummy pixels need not be provided, and all pixels 120 included in pixel array 110 may be the first pixels.

Driving circuit 130 is a circuit that controls each of pixels 120. Driving circuit 130 and each pixel 120 are electrically connected via control lines 150. Driving circuit 130 drives each control line 150. Specifically, driving circuit 130 outputs a control signal to each control line 150, to control the exposure timing of each pixel 120 and the signal output timing of each pixel 120.

Signal outputting circuit 140 is connected to each pixel 120 via vertical signal lines 160. Signal outputting circuit 140 outputs, to ISP 13, an image signal read out from each pixel 120 or each pixel via vertical signal lines 160, as the sensor output data.

### [Pixel]

A configuration of pixel 120 and an arrangement of pixels 120 are described in detail. FIG. 3 is a circuit diagram illustrating an example of a circuit configuration of pixel 120 according to the embodiment. Pixel 120 includes photoelectric converter 121, transfer transistor 122, charge storage 123, charge drain transistor 124, source follower transistor 125, select transistor 126, and reset transistor 127. Each of transfer transistor 122, charge storage 123, charge drain transistor 124, source follower transistor 125, select transistor 126, and reset transistor 127 is, for example, an N-channel metal-oxide-semiconductor FET (MOSFET). The circuit configuration of pixel 120 illustrated in FIG. 3 applies to, for example, both the first pixels that generate distance detection signals and the second pixels that generate phase difference detection signals. It should be noted that the circuit configuration of pixel 120 illustrated in FIG. 3 is a mere example and can be changed as necessary. Moreover, the circuit configuration of the first pixels may differ from that of the second pixels.

Photoelectric converter 121 generates charge by converting the light incident on pixel 120 into charge. The light incident on pixel 120 includes, for example, the reflected light from target object 2 in response to the pulsed light emitted from light source 11. Photoelectric converter 121 includes, for example, a photoelectric conversion device, such as a photodiode. Photoelectric converter 121 is connected to one of the source or drain of transfer transistor 122 and connected to one of the source or drain of charge drain transistor 124.

Transfer transistor 122 transfers the charge converted by photoelectric converter 121 from photoelectric converter 121 to charge storage 123. The other of the source or drain of transfer transistor 122 is connected to charge storage 123. Transfer control signal TG that controls ON and OFF of transfer transistor 122 is applied to the gate of transfer transistor 122. Transfer control signal TG is a sensor exposure pulse generated inside solid-state image sensor 100 based on the sensor control pulse obtained from ISP 13.

Charge storage 123 stores the charge converted by photoelectric converter 121 and transferred by transfer transistor 122. Specifically, the charge converted by photoelectric converter 121 during the exposure of pixel 120 is stored in charge storage 123. Charge storage 123 is, for example, an impurity region which is formed in a semiconductor substrate and which cannot enter a floating state. Moreover, charge storage 123 may include interconnect capacitance.

Charge drain transistor 124 drains the charge converted by photoelectric converter 121 to the outside of pixel 120. Power supply voltage VDD is applied to the other of the source or drain of charge drain transistor 124. Charge drain control signal PRS that controls ON and OFF of charge drain transistor 124 is applied to the gate of charge drain transistor 124.

Source follower transistor 125 outputs a signal corresponding to the electric potential of charge storage 123. That is, source follower transistor 125 reads out the charge stored in charge storage 123. The gate of source follower transistor 125 is connected to charge storage 123. Power supply voltage VDD is applied to one of the source or drain of source follower transistor 125. The other of the source or drain of source follower transistor 125 is connected to one of the source or drain of select transistor 126, and outputs, to bit line BL, a signal corresponding to the electric potential of charge storage 123 via select transistor 126. Source follower transistor 125 as well as a current source connected to bit line BL form a source follower circuit.

The other of the source or drain of select transistor 126 is connected to bit line BL, which is a signal line to which a signal from pixel 120 is output. Select control signal SEL that controls ON and OFF of select transistor 126 is applied to the gate of select transistor 126. When select transistor 126 is turned on, source follower transistor 125 reads out charge. For example, the signal from pixel 120 output to bit line BL is converted into a digital signal by a not-illustrated AD conversion circuit and then input into distance calculator 132.

Reset transistor 127 resets the electric potential of charge storage 123. One of the source or drain of reset transistor 127 is connected to charge storage 123. Power supply voltage VDD is applied to the other of the source or drain of reset transistor 127. Reset control signal RS that controls ON and OFF of reset transistor 127 is applied to the gate of reset transistor 127. When reset transistor 127 is turned on, the electric potential of charge storage 123 is reset to power supply voltage VDD.

For instance, based on control signals from drive controller 131 (ISP 13), driving circuit 130 generates transfer control signal TG, charge drain control signal PRS, select control signal SEL, and reset control signal RS.

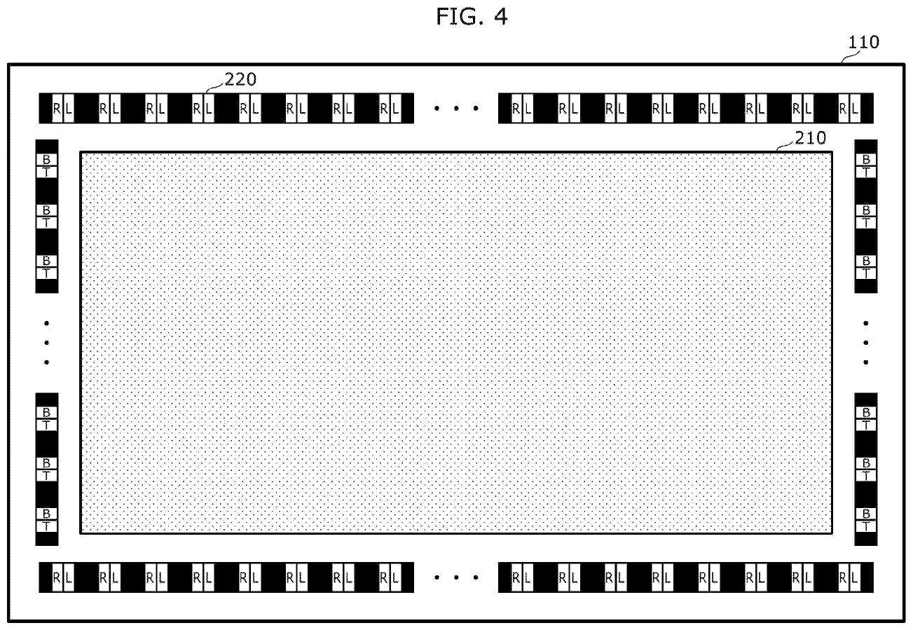

Next, an arrangement of pixels 120 is described. FIG. 4 illustrates an example of an arrangement of pixels 120 in pixel array 110 according to the embodiment.

As illustrated in FIG. 4, effective pixel area 210 and phase difference detection area 220 are provided in pixel array 110.

In the example illustrated in FIG. 4, rectangular effective pixel area 210 is set in the center of pixel array 110. Effective pixel area 210 is an area in which to generate a TOF image. First pixels that generate distance detection signals are disposed in effective pixel area 210.

In the example illustrated in FIG. 4, phase difference detection areas 220 are disposed along a peripheral portion of pixel array 110 to surround rectangular effective pixel area 210. Phase difference detection area 220 is an area for detecting a phase difference. Second pixels that generate phase difference detection signals are disposed in phase difference detection area 220.

Here, in the example illustrated in FIG. 4, phase difference detection area 220 is formed using second pixels aligned in a single row. However, the second pixels may be aligned in two or more rows. Although this is disadvantageous in terms of chip size, detection of a distance value by the second pixels is made easier.

Moreover, in the example illustrated in FIG. 4, phase difference detection areas 220 are disposed along all four sides of effective pixel area 210. However, phase difference detection areas 220 need not be disposed along all four sides. Although this makes it difficult for the second pixels to detect a distance value, this is advantageous in terms of chip size.

Here, divided light-receiving areas of second pixels are arranged in the same direction as an extending direction of phase difference detection area 220. That is, for second pixels included in horizontally extending phase difference detection area 220, divided light-receiving areas are arranged horizontally. For second pixels included in vertically extending phase difference detection area 220, divided light-receiving areas are arranged vertically. In the example illustrated in FIG. 4, each of the second pixels is a portion with one of the letters R, L, B, or T, which is a light-receiving area, that is, an aperture. Moreover, in the example illustrated in FIG. 4, a solid black area is an area that does not receive light. As a non-limiting example, the area that does not receive light is created by providing a light shield.

It should be noted that pixels 120 other than the first pixels may be disposed in effective pixel area 210. Pixels, such as second pixels or dummy pixels, may be disposed in effective pixel area 210. Moreover, pixels 120 other than the second pixels may be disposed in phase difference detection area 220. Pixels, such as first pixels or dummy pixels, may be disposed in phase difference detection area 220.

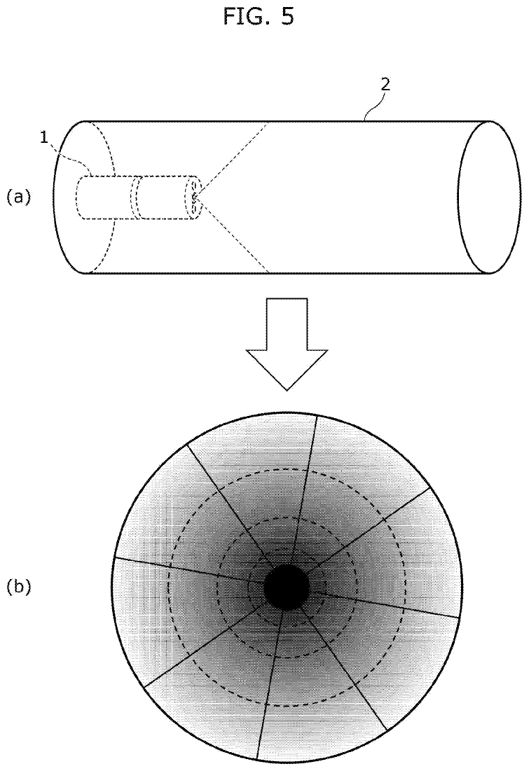

FIG. 5 illustrates a situation where distance imaging apparatus 1 according to the embodiment is used as an endoscopy system. (a) in FIG. 5 illustrates distance imaging apparatus 1 capturing an image. (b) in FIG. 5 illustrates an image of a distance image generated by imaging in (a) in FIG. 5. The distance image illustrated in (b) in FIG. 5 indicates that the distance value increases as the black becomes darker.

As illustrated in (a) in FIG. 5, given the situation where an image of tubular target object 2 in a tube direction is captured with insertion section 20 of distance imaging apparatus 1 inserted into target object 2, the obtained distance image indicates, as shown in (b) in FIG. 5, that the closer to the center, the greater the distance; the closer to the periphery, the shorter the distance.

Here, as distance-measuring characteristics of phase difference pixels, the following is known in general: phase difference pixels can measure the distance more accurately as they are closer to the subject. Accordingly, as illustrated in FIG. 4, phase difference detection areas 220 are provided in the peripheral portion of pixel array 110, and second pixels (phase difference pixels) are disposed in phase difference detection areas 220. By doing so, the second pixels can calculate a distance measurement value more accurately, which, in turn, contributes to improvement in the accuracy of correction.

Moreover, arranging phase difference detection areas 220 outside effective pixel area 210 makes it easier to change the pixel size of the second pixels included in phase difference detection areas 220 and control the second pixels. Moreover, it is possible to avoid degradation of a TOF image obtained by effective pixel area 210.

### [Operation]

Next, an operation of distance imaging apparatus 1 according to the embodiment is described. Distance imaging apparatus 1 according to the embodiment can correct the phase difference between an irradiation pulse and an exposure pulse caused by the fact that light source 11 that emits light and solid-state image sensor 100 that performs exposure to reflected light are positioned apart from each other.

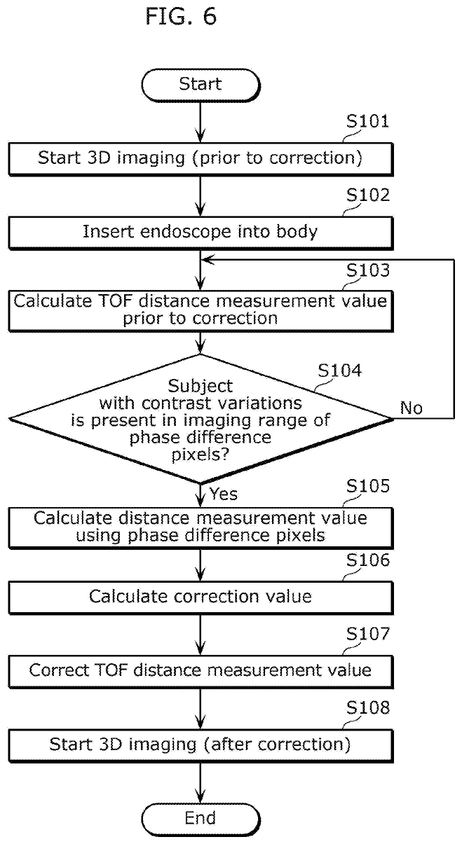

Hereinafter, an operation where distance imaging apparatus 1 is used as an endoscope is described. FIG. 6 is a flowchart illustrating an operation of distance imaging apparatus 1 according to the embodiment.

First, distance imaging apparatus 1 starts 3D imaging (prior to correction) (S101). In other words, distance imaging apparatus 1 starts measuring the distance. That is, drive controller 131 outputs an emission control pulse to light source 11 and a sensor control pulse to solid-state image sensor 100.

Next, an endoscope is inserted into the body (S102). That is, insertion section 20 of distance imaging apparatus 1 is inserted into the body. Light source 11 is included in main body 10, and solid-state image sensor 100 is provided near an end portion of insertion section 20. Accordingly, the distance between light source 11 and solid-state image sensor 100 increases as insertion section 20 becomes longer. This increases, in a cable end portion, the phase difference between a sensor exposure pulse and an irradiation light pulse due to the propagation delay. Moreover, the phase difference varies depending on how insertion section 20 bends, that is, the internal shape of the body. Moreover, the phase difference varies depending on the internal body temperature or the like. It should be noted that the order of steps S101 and S102 may be swapped, or steps S101 and S102 may be performed simultaneously.

Then, distance calculator 132 calculates a TOF distance measurement value prior to the correction (S103). Specifically, distance calculator 132 calculates the first distance to target object 2 based on the distance detection signals generated by the first pixels. The procedure for calculating the first distance is described later.

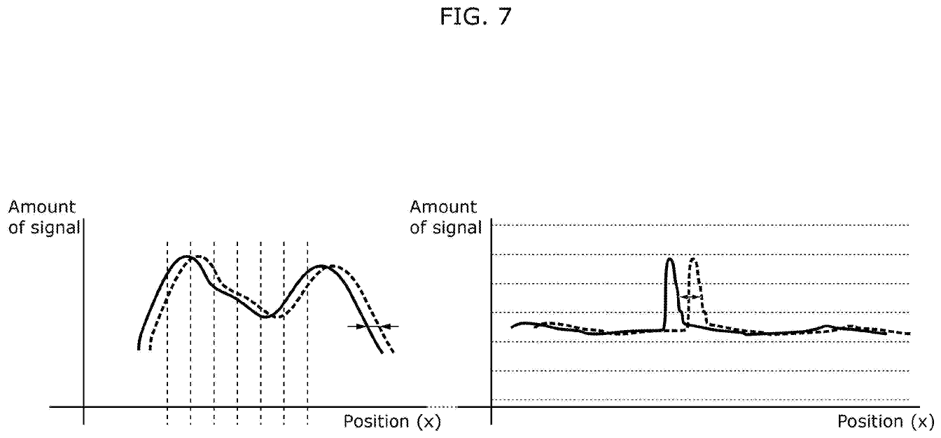

Here, whether a subject with contrast variations is present in the imaging range of the phase difference pixels is determined (S104). FIG. 7 illustrates parallax detection by the phase difference pixels. The solid line in each graph illustrated in FIG. 7 illustrates outputs from right-aperture pixels among the phase difference pixels. The dashed line in each graph indicates outputs from left-aperture pixels among the phase difference pixels. A double-pointed arrow indicates parallax detected by the phase difference pixels. As illustrated in FIG. 7, when the outputs from the right-aperture pixels are equal to the outputs from the left-aperture pixels, that is, when the focus position corresponds to the subject distance, no parallax occurs. When the focus is not at the subject position, since the outputs from the right-aperture pixels differ from those from the left-aperture pixels, parallax occurs. In other words, parallax can be detected only when the subject has contrast variations.

Here, the determination is performed based on the actual result of image capturing by the phase difference pixels. Moreover, a user of distance imaging apparatus 1, such as a doctor, may perform the determination.

When a subject with contrast variations is not present in the imaging range of the phase difference pixels (No in S104), distance imaging apparatus 1 returns to the processing in step S103, and continues to generate a TOF image.

When a subject with contrast variations is present in the imaging range of the phase difference pixels (Yes in S104), correction processor 133 calculates a distance measurement value using the phase difference pixels (S105). Specifically, correction processor 133 calculates the second distance to target object 2 based on the phase difference detection signals generated by the second pixels. The procedure for calculating the second distance is described later.

Then, correction processor 133 calculates a correction value (S106). Specifically, correction processor 133 calculates a correction value for correcting the first distance, based on the first distance calculated in step S103 and the second distance calculated in step S105.

Here, correction processor 133 identifies, from among the second pixels, second pixels that have generated the phase difference detection signals used for calculating the second distance in step S105. Correction processor 133 identifies, from among the first pixels, one or more first pixels disposed near the identified second pixels. Correction processor 133 calculates the correction value based on the first distance calculated based on the distance detection signals generated by the identified one or more first pixels and the second distance calculated based on the phase difference detection signals generated by the identified second pixels. This can improve the accuracy of correction.

Then, correction processor 133 corrects the TOF (S107). Correction processor 133 corrects the TOF based on the calculated correction value. A TOF correction method is described later.

Finally, distance imaging apparatus 1 starts 3D imaging (after correction) (S108).

According to the above operation, by using the distance measurement value calculated using the phase difference pixels, it is possible to correct the phase difference between the timing of irradiation light and the timing of exposure, which is caused by the large distance between light source 11 and solid-state image sensor 100. In other words, based on the second distance calculated based on the phase difference detection signals generated by the phase difference pixels, it is possible to correct the first distance calculated based on the distance detection signals generated by the TOF pixels. Accordingly, distance imaging apparatus 1 can easily correct the distance measurement value.

It should be noted that a user may correct the first distance at their desired timing by, for example, pressing a button. For instance, the user may instruct performing of the correction via the operator included in distance imaging apparatus 1.

Moreover, the first distance may be corrected when the environment, such as temperature, changes. For instance, insertion section 20 includes a temperature sensor, and the correction may be performed when the temperature of the cable end portion is changed.

Moreover, the first distance may be corrected based on the correction value calculated in a previous correction. For instance, the correction value may be stored in system control circuit 15, and a correction may be performed based on the correction value.

Moreover, the first distance may be corrected in a state where insertion section 20 is set in a calibration case, before insertion section 20 is inserted into the body. The calibration case is, for example, a case that replicates the environment of target object 2, such as the shape and temperature. That is, the correction may be performed prior to the processing in step S102.

Moreover, the correction of the first distance may be repeated at regular intervals. That is, the correction may be automatically performed at predetermined intervals to adapt to a change in the environment. Although the predetermined intervals are, for example, one minute or 30 seconds, the predetermined intervals are not particularly limited here.

Moreover, if contrast variations are not present in the imaging range of the phase difference pixels when the correction of the first distance is requested, inability to execute the correction may be notified to the user.

### [Calculation of First Distance]

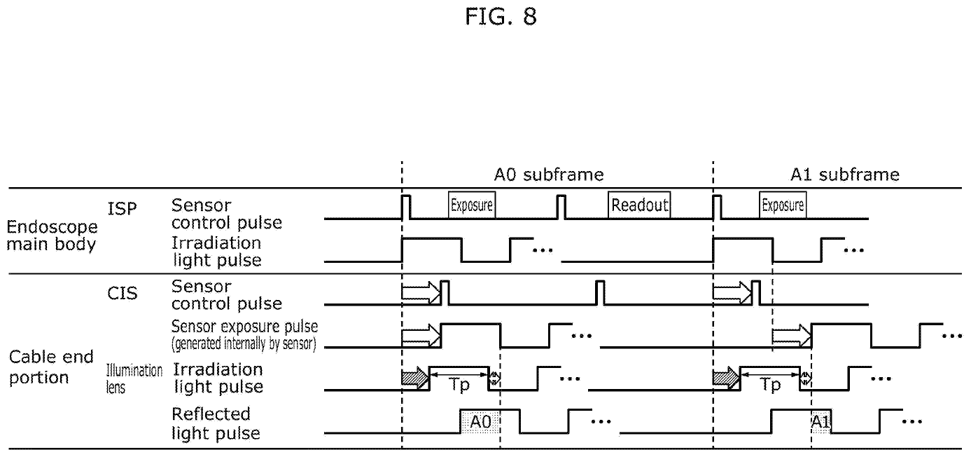

The procedure for calculating the first distance is described. That is, a procedure for distance calculator 132 to calculate the first distance in step S103 is described. FIG. 8 is a timing chart illustrating an imaging operation of the distance imaging apparatus according to the embodiment performed prior to the correction.

As illustrated in FIG. 8, drive controller 131 of ISP 13 outputs a sensor control pulse and an irradiation light pulse. Using pulsed light with pulse width (duration) Tp as irradiation light, light source 11 repeatedly irradiates target object 2 at predetermined time intervals.

The reflected light is delayed relative to the pulsed light by certain time ΔT, depending on the distance to target object 2. In a pulsed TOF method, light is received during at least two exposure periods that are set at relatively different times with respect to the pulsed light. In the example illustrated in FIG. 8, a period with pulse width Tp that starts simultaneously with the pulsed light is set as a first exposure period, and a period with pulse width Tp that starts simultaneously with the stopping of the pulsed light is set as a second exposure period.

First distance Z to target object 2 is expressed by the following Expression (1) based on delay time ΔT.

$$\begin{matrix}[ Math . 1 ] & \\ Z = \frac{c}{2} \times Δ T = \frac{c}{2} \times \frac{A 1}{A 0 + A 1} \times T p & ( 1 )\end{matrix}$$

A0 indicates the intensity of reflected light received during the first exposure period, and A1 indicates the intensity of reflected light received during the second exposure period.

In the pulsed TOF method, the accuracy of distance measurement can be enhanced by reducing pulse width Tp. Meanwhile, reducing pulse width Tp results in a decreased distance measurable range (distance measurement range). This is because maximum value Zmax of measurable distance Z is a value when A0=0 in Expression (1), and is expressed as (c×Tp)/2. To deal with the reduction in the distance measurement range, the distance is measured by performing more than one exposure, and measurement results are combined, which enables expansion of the distance measurement range.

It should be noted that a third exposure period may be set as a period with no possibility of receiving reflected light. The third exposure period is provided to detect background light components. In this case, A0 is obtained by subtracting the signal intensity (background light components) obtained during the third exposure period from the signal intensity obtained during the first exposure period, and A1 is obtained by subtracting the signal intensity (background light components) obtained during the third exposure period from the signal intensity obtained during the second exposure period.

### [Error Included in First Distance]

FIG. 8 illustrates propagation delays of a sensor control pulse generated by drive controller 131 of ISP 13 and an irradiation light pulse emitted by light source 11.

Drive controller 131 generates and outputs an emission control pulse to light source driving circuit 12. Light source driving circuit 12 drives light source 11 in accordance with the emission control pulse, and light source 11 emits an irradiation light pulse. The irradiation light pulse emitted by light source 11 is emitted from the end portion of insertion section 20 via light guide member 21. As illustrated in FIG. 8, the irradiation light pulse in the illumination lens of the cable end portion is delayed relative to the irradiation light pulse in the main body of the endoscope by the time it takes to pass through light guide member 21. In FIG. 8, the magnitude of the delay is indicated by a right arrow with diagonal stripes.

Moreover, drive controller 131 generates and outputs a sensor control pulse to solid-state image sensor 100. Solid-state image sensor 100 generates a sensor exposure pulse based on the obtained sensor control pulse, and performs exposure to reflected light. As illustrated in FIG. 8, the sensor control pulse obtained by solid-state image sensor 100 is delayed relative to the sensor control pulse output by drive controller 131 by the time it takes to reach the cable end portion. In FIG. 8, the magnitude of the delay is indicated by a hollow right arrow. The sensor exposure pulse generated based on the sensor control pulse is delayed by the same amount as the sensor control pulse.

Here, as described above, to calculate the accurate value of first distance Z based on Expression (1), the first exposure period needs to start simultaneously with the pulsed light, and the second exposure period needs to start simultaneously with the stopping of the pulsed light.

However, as illustrated in FIG. 8, since the magnitude of the delay of the irradiation light pulse differs from that of the delay of the sensor exposure pulse, a phase difference occurs between the irradiation light pulse and the sensor exposure pulse. In FIG. 8, the magnitude of the phase difference that occurs between the irradiation light pulse and sensor exposure pulse is indicated by a double-pointed hollow arrow. First distance Z calculated in step S103 includes an error caused by the phase difference.

### [Calculation of Second Distance]

The procedure for calculating the second distance is described. That is, a procedure for correction processor 133 to calculate the second distance in step S105 in FIG. 6 is described.

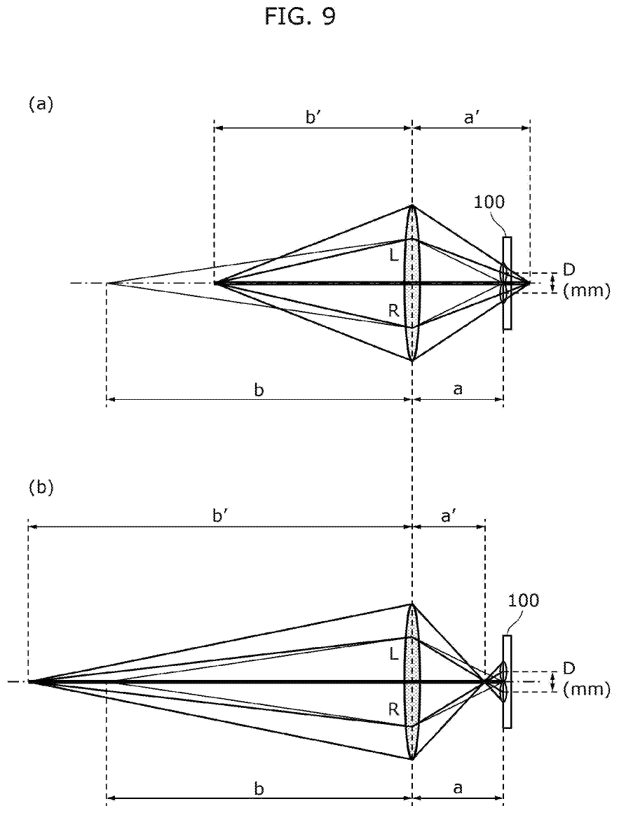

FIG. 9 illustrates a relationship between parallax and a phase difference. (a) in FIG. 9 illustrates a relationship between parallax and a phase difference when target object 2 is closer than the focus position. (b) in FIG. 9 illustrates a relationship between parallax and a phase difference when target object 2 is further than the focus position.

In FIG. 9, the distance from the lens to target object 2 is indicated by b′.

When a focal length determined by a lens coefficient is defined as f, and the distance between the lens and the position at which a real image of target object 2 is formed is defined as a′, b′ is expressed using the following Expression (2).

b′=1/(1/f−1) (2)

When the focus position determined by settings of the lens during image capturing is set to (a+b), the base line length of the lens determined by the lens coefficient is defined as b1, and parallax is defined as D, a′ is expressed using the following Expression (3).

a′=b|*a/(b1−D) (3)

Here, as illustrated in FIG. 7, parallax D is calculated using the outputs of second pixels. Specifically, parallax D is calculated from the distance between a second pixel that has received light incident on an L aperture pixel and a second pixel that has received light incident on an R aperture pixel.

Accordingly, since a and bl are constants, the value of b′ can be calculated based on Expressions (2) and (3), by calculating parallax D. That is, the second distance (=a+b′) can be calculated.

### [Correction Method]

Next, a TOF correction method is described. That is, a correction method in the processing of step S107 is described.

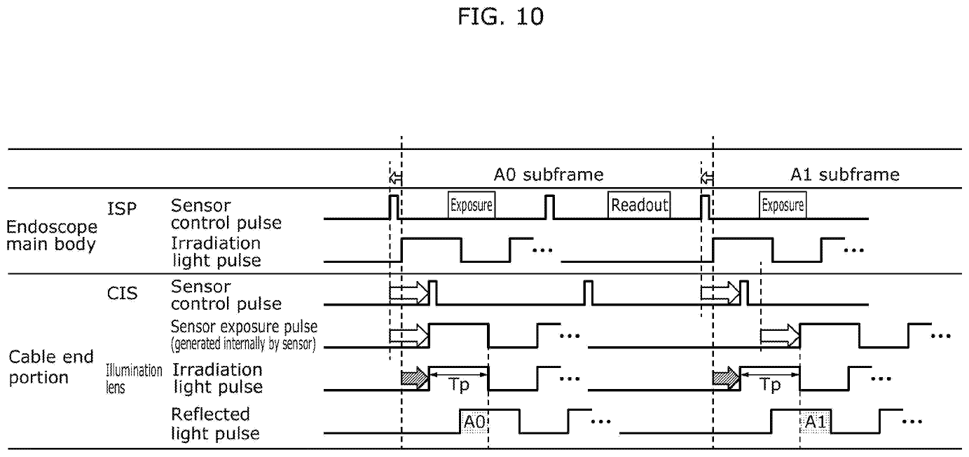

Moreover, for instance, correction processor 133 performs correction by drive controller 131 adjusting the output timings of an emission control pulse and a sensor control pulse to correct the difference between the first distance and the second distance. FIG. 10 is a timing chart illustrating an imaging operation of the distance imaging apparatus according to the embodiment performed after the correction.

As illustrated in FIG. 10, correction processor 133 performs correction by calculating the difference between the magnitude of the delay of the irradiation light pulse and that of the delay of the sensor control pulse, illustrated in FIG. 8, and adjusting the timing at which drive controller 131 outputs the sensor control pulse, to compensate the difference. Specifically, in FIG. 10, drive controller 131 advances the output timing of the sensor control pulse by the amount indicated by a hollow left arrow. In this way, it is possible to adjust the relationship between the timing of the irradiation light pulse and the timing of the sensor exposure pulse, to an appropriate one for the position of solid-state image sensor 100. That is, using such a correction method, drive controller 131 can correct a distance measurement value by adjusting the driving instruction timing. As a result of the correction, a correct distance image is output. This contributes to a reduction in the number of processes performed after generation of the distance image.

For instance, correction processor 133 corrects the value of the first distance, based on the difference between the first distance and the second distance. Specifically, correction processor 133 performs the correction by calculating the difference between first distance Z and the second distance (a+b′), as the correction value, and subtracting the difference from the distance value of the entire TOF image.

By using such a correction method, correction processor 133 can correct the distance measurement value by calculating the difference between the first distance and the second distance, and subtracting the difference. Accordingly, correction processor 133 can perform the correction through the processing performed after the generation of the distance image, without changing the driving timing.

### [Variations]

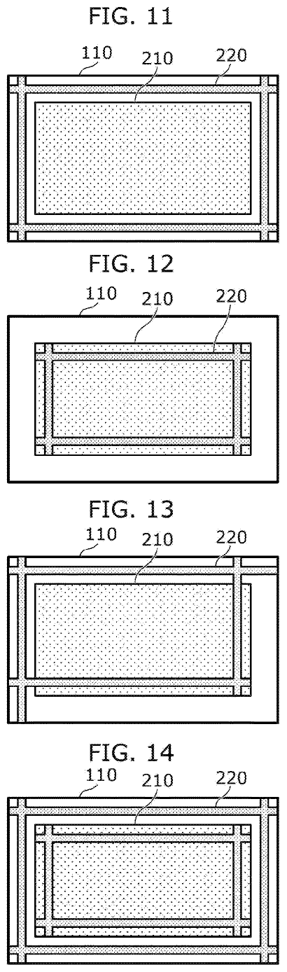

Here, an arrangement of pixels 120 in pixel array 110 is not limited to the example described with reference to FIG. 4. Hereinafter, examples of arrangements of pixels 120 in pixel array 110, that is, arrangements of effective pixel area 210 and phase difference detection areas 220 in pixel array 110 are described with reference to FIGS. 11 to 18.

A first example of pixels 120 is described. FIG. 11 illustrates a first example of an arrangement of pixels 120 in pixel array 110 according to the embodiment.

As illustrated in FIG. 11, rectangular effective pixel area 210 may be provided in the center of pixel array 110, and phase difference detection areas 220 may be provided outside effective pixel area 210, along the four sides of effective pixel area 210.

A second example of pixels 120 is described. FIG. 12 illustrates a second example of an arrangement of pixels 120 in pixel array 110 according to the embodiment.

As illustrated in FIG. 12, rectangular effective pixel area 210 may be provided in the center of pixel array 110, and phase difference detection areas 220 may be provided inside effective pixel area 210, along the four sides of effective pixel area 210.

A third example of pixels 120 is described. FIG. 13 illustrates a third example of an arrangement of pixels 120 in pixel array 110 according to the embodiment.

As illustrated in FIG. 13, rectangular effective pixel area 210 is provided in the center of pixel array 110, phase difference detection areas 220 may be provided outside effective pixel area 210, along two of the four sides of effective pixel area 210, and phase difference detection area 220 may be provided inside effective pixel area 210, along the other two of the four sides of effective pixel area 210.

A fourth example of pixels 120 is described. FIG. 14 illustrates a fourth example of an arrangement of pixels 120 in pixel array 110 according to the embodiment.

As illustrated in FIG. 14, rectangular effective pixel area 210 may be provided in the center of pixel array 110, and phase difference detection areas 220 may be provided both inside and outside effective pixel area 210, along the four sides of effective pixel area 210.

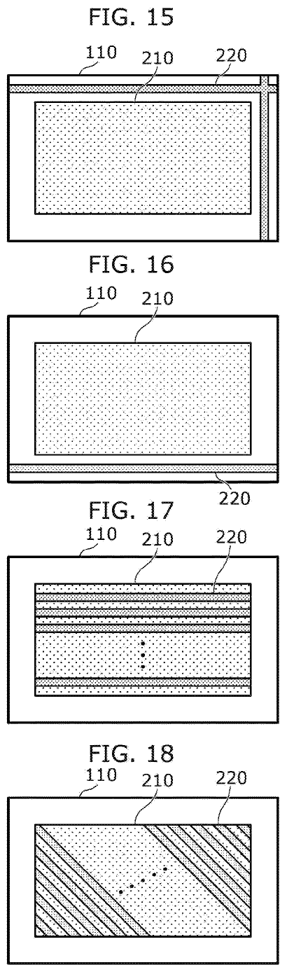

A fifth example of pixels 120 is described. FIG. 15 illustrates a fifth example of an arrangement of pixels 120 in pixel array 110 according to the embodiment.

As illustrated in FIG. 15, rectangular effective pixel area 210 may be provided in the center of pixel array 110, and phase difference detection areas 220 may be provided outside effective pixel area 210, along two of the four sides of effective pixel area 210.

A sixth example of pixels 120 is described. FIG. 16 illustrates a sixth example of an arrangement of pixels 120 in pixel array 110 according to the embodiment.

As illustrated in FIG. 16, rectangular effective pixel area 210 may be provided in the center of pixel array 110, and phase difference detection area 220 may be provided outside effective pixel area 210, along one of the four sides of effective pixel area 210.

A seventh example of pixels 120 is described. FIG. 17 illustrates a seventh example of an arrangement of pixels 120 in pixel array 110 according to the embodiment.

As illustrated in FIG. 17, rectangular effective pixel area 210 may be provided in the center of pixel array 110, and horizontally extending phase difference detection areas 220 may be provided inside effective pixel area 210.

It should be noted that FIG. 17 illustrates horizontally extending phase difference detection areas 220 that are arranged inside effective pixel area 210. However, vertically extending phase difference detection areas 220 may be provided inside effective pixel area 210.

An eighth example of pixels 120 is described. FIG. 18 illustrates an eighth example of an arrangement of pixels 120 in pixel array 110 according to the embodiment.

As illustrated in FIG. 18, rectangular effective pixel area 210 may be provided in the center of pixel array 110, and diagonally extending phase difference detection areas 220 may be provided inside effective pixel area 210. It should be noted that a diagonal direction may be a direction sloping up to the left or a direction sloping up to the right.

Moreover, arrangements of effective pixel area 210 and phase difference detection areas 220 in pixel array 110 may be achieved by any combination of the first to eighth examples. Moreover, effective pixel area 210 need not be rectangular.

Provision of phase difference detection area 220 inside effective pixel area 210 can reduce the chip size. Furthermore, it is possible to decrease the distance between the first pixels and the second pixels used for correction, which enables more accurate calculation of a correction value.

It should be noted that aspects of arrangements of effective pixel area 210 and phase difference detection areas 220 in pixel array 110 are not limited to the above examples. As long as the phase difference can be detected using phase difference detection area 220, aspects of arrangements of pixels 120 are not particularly limited. In other words, as long as at least one set of second pixels aligned in a direction is provided, aspects of arrangements of pixels 120 are not particularly limited.

### OTHER EMBODIMENTS

Although an embodiment is described above, the present disclosure is not limited to the above embodiment.

Although a method for controlling a distance imaging apparatus according to one or more aspects is described above based on the embodiment, the present disclosure is not limited to the embodiment. The present disclosure encompasses embodiments obtained by adding various modifications envisioned by those skilled in the art to the embodiment as well as embodiments created by combining elements from different embodiments, provided that the resultant embodiments are within the scope of the present disclosure.

For instance, in the above embodiment, the distance imaging apparatus calculates a distance value using a pulsed TOF method. However, the distance imaging apparatus may calculate a distance value using a continuous-wave (CW) TOF method.

For instance, in the above embodiment, an endoscopy system is indicated as a non-limiting example of the distance imaging apparatus. The distance imaging apparatus may be, for example, a monitoring camera or an object detection device provided to a predetermined building or structure. Alternatively, the distance imaging apparatus may be a sensor device included in a mobile object, such an autonomous driving vehicle or a drone. It should be noted that in these cases, target object 2 is an object, such as a stationary object or a mobile object.

Moreover, for instance, a visible light image need not be an RGB image. A visible light image may be a single-color image, such as a monochrome image. Moreover, for instance, a first wavelength of light used in a first operation mode may be the same as a second wavelength of flashing light used in a second operation mode.

Moreover, the communication methods between devices described in the above embodiment are not particularly limited. When wireless communication is performed between devices, a wireless communication system (communication standard) is, for example, short-range wireless communication, such as ZigBee (registered trademark), Bluetooth (registered trademark), or wireless local area network (LAN). Alternatively, a wireless communication system (communication standard) may be communication via a wide area network, such as the Internet. Moreover, wired communication may be performed between devices instead of wireless communication. Specifically, wired communication is, for example, communication using power line communication (PLC) or wired LAN.

Moreover, in the above embodiment, processing performed by a particular processor may be performed by another processor. Moreover, the order of processes may be changed, or processes may be performed in parallel. Moreover, the distribution of the elements of the distance imaging apparatus (a distance measuring system) to apparatuses is a mere example. For instance, one or more elements of one apparatus may be included in another apparatus.

For instance, the processing described in the above embodiment may be implemented by performing centralized processing using a single apparatus (system) or by performing distributed processing using a plurality of apparatuses. Moreover, a processor that performs the above program may be a single processor or a plurality of processors. That is, centralized processing or distributed processing may be performed.

Moreover, in the above embodiment, all or some elements, including the controller, may be implemented as dedicated hardware or may be implemented by executing a software program suitable for each element. Each element may be implemented by a program executer, such as a central processing unit (CPU) or a processor, reading out and executing a software program stored in a recording medium, such as a hard disk drive (HDD) or semiconductor memory.

Moreover, each element, such as the controller, may include one or more electronic circuits. Moreover, each of the one or more electronic circuits may be a general-purpose circuit or a dedicated circuit.

The one or more electronic circuits may include, for example, a semiconductor device, an IC, or an LSI. The IC or LSI may be integrated into one or more chips. Although it is referred to as an IC or an LSI here, it may be referred to as a system LSI, a very large scale integration (VLSI), or an ultra large scale integration (ULSI) depending on the degree of integration. Moreover, a FPGA programmed after manufacturing an LSI can be used for the same purpose.

Moreover, a general or specific aspect of the present disclosure may be implemented as a system, an apparatus, a method, an integrated circuit, or a computer program. Alternatively, the general or specific aspect may be implemented as a non-transitory computer-readable recording medium storing the computer program, such as an optical disk, an HDD, or semiconductor memory. Moreover, the general or specific aspect may be implemented as any combination of the system, apparatus, method, integrated circuit, computer program, and recording medium.

Moreover, in the above embodiment, various changes, replacement, addition, omission, and so forth can be performed within the scope of the claims or equivalents thereof.

Although only one exemplary embodiment of the present disclosure has been described in detail above, those skilled in the art will readily appreciate that many modifications are possible in the exemplary embodiment without materially departing from the novel teachings and advantages of the present disclosure. Accordingly, all such modifications are intended to be included within the scope of the present disclosure.

### INDUSTRIAL APPLICABILITY

The present disclosure can be used as an imaging apparatus usable in highly accurate distance measurement, and is applicable to, for example, an endoscopy system, a monitoring camera, and so forth.

1. A solid-state image sensor comprising:
a pixel array in which a plurality of pixels including first pixels and second pixels are arranged two-dimensionally, wherein
each of the first pixels is exposed to reflected light of irradiation light from a target object, based on an exposure signal that is synchronized with a light emission signal, to generate a distance detection signal,
each of the second pixels generates a phase difference detection signal based on light incident from pupil-divided regions of the reflected light,
the pixel array includes one or more phase difference detection areas in each of which two or more second pixels among the second pixels are aligned in one direction, and
within the pixel array, one or more first pixels among the first pixels are each disposed at a location that differs from each location of the one or more phase difference detection areas and that is closer to a center of the pixel array than at least one phase difference detection area of the one or more phase difference detection areas is.

2. The solid-state image sensor according to claim 1, wherein
a total number of the first pixels is greater than a total number of the second pixels.

3. The solid-state image sensor according to claim 1, wherein
the first pixels have a mode for generating a visible light image signal.

4. The solid-state image sensor according to claim 1, wherein
the one or more phase difference detection areas include a first phase difference detection area in which the two or more second pixels are aligned in a first direction and a second phase difference detection area in which the two or more second pixels are aligned in a second direction orthogonal to the first direction, and
the two or more second pixels aligned in the first phase difference detection area receive light incident from pupil-divided regions in the first direction, and the two or more second pixels aligned in the second phase difference detection area receive light incident from pupil-divided regions in the second direction.

5. The solid-state image sensor according to claim 1, wherein
a size of each of the second pixels differs from a size of each of the first pixels.

6. The solid-state image sensor according to claim 1, wherein
the pixel array includes an effective pixel area in which some of the first pixels are arranged two-dimensionally, and the one or more phase difference detection areas are disposed outside the effective pixel area.

7. The solid-state image sensor according to claim 1, wherein
the pixel array includes an effective pixel area in which some of the first pixels are arranged two-dimensionally, and the one or more phase difference detection areas are disposed inside the effective pixel area.

8. The solid-state image sensor according to claim 1, wherein
the pixel array includes an effective pixel area in which some of the first pixels are arranged two-dimensionally, and the one or more phase difference detection areas include a phase difference detection area disposed outside the effective pixel area and a phase difference detection area disposed inside the effective pixel area.

9. The solid-state image sensor according to claim 1, wherein
the pixel array includes an effective pixel area in which some of the first pixels are arranged two-dimensionally, and the one or more phase difference detection areas are each disposed along a side of the effective pixel area.

10. The solid-state image sensor according to claim 1, wherein
the one or more phase difference detection areas are a plurality of phase difference detection areas arranged in a predetermined direction.

11. The solid-state image sensor according to claim 1, wherein
the one or more phase difference detection areas include a phase difference detection area in which the two or more second pixels are aligned in a first direction and a phase difference detection area in which the two or more second pixels are aligned in a second direction orthogonal to the first direction.

12. A distance imaging apparatus comprising:
the solid-state image sensor according to claim 1;
a light source that irradiates a target object with the irradiation light;
a distance calculator that calculates a first distance to the target object based on the distance detection signals generated by the first pixels;
a drive controller that outputs (i) the light emission signal that instructs the light source to emit the irradiation light and (ii) the exposure signal that instructs the solid-state image sensor to expose the plurality of pixels; and
a correction processor that calculates a second distance to the target object based on the phase difference detection signals generated by the second pixels, and performs processing for correcting the first distance based on the first distance and the second distance.

13. The distance imaging apparatus according to claim 12, wherein
the correction processor adjusts timings at which the drive controller outputs the light emission signal and the exposure signal, to correct a difference between the first distance and the second distance.

14. The distance imaging apparatus according to claim 12, wherein
the correction processor corrects a value of the first distance based on a difference between the first distance and the second distance.

15. The distance imaging apparatus according to claim 12, wherein
the correction processor performs the processing for correcting the first distance when the reflected light incident on the one or more phase difference detection areas has contrast variations.

16. A distance imaging apparatus comprising:
a solid-state image sensor including a pixel array in which a plurality of pixels including first pixels and second pixels are arranged two-dimensionally;
a light source that irradiates a target object with irradiation light;
a distance calculator;
a drive controller; and
a correction processor, wherein
each of the first pixels is exposed to reflected light of the irradiation light from the target object, based on an exposure signal that is synchronized with a light emission signal, to generate a distance detection signal,
each of the second pixels generates a phase difference detection signal based on light incident from pupil-divided regions of the reflected light,
the distance calculator calculates a first distance to the target object based on the distance detection signals generated by the first pixels,
the drive controller outputs the light emission signal to the light source and the exposure signal to the solid-state image sensor, and
the correction processor calculates a second distance to the target object based on the phase difference detection signals generated by the second pixels, and performs processing for correcting the first distance based on the first distance and the second distance.

17. A distance measuring method using the solid-state image sensor according to claim 1, the distance measuring method comprising:
outputting the light emission signal to a light source that irradiates the target object with the irradiation light and the exposure signal to the solid-state image sensor;
obtaining the distance detection signals from the solid-state image sensor, and calculating a first distance to the target object based on the distance detection signals; and
calculating a second distance to the target object based on the phase difference detection signals generated by the second pixels, and performing processing for correcting the first distance based on the first distance and the second distance.

18. A distance measuring method performed by a distance imaging apparatus,
the distance imaging apparatus including:
a light source that irradiates a target object with irradiation light; and
a solid-state image sensor including a pixel array in which a plurality of pixels including first pixels and second pixels are arranged two-dimensionally, wherein
each of the first pixels is exposed to reflected light of the irradiation light from the target object, based on an exposure signal that is synchronized with a light emission signal, to generate a distance detection signal, and
each of the second pixels generates a phase difference detection signal based on light incident from pupil-divided regions of the reflected light,
the distance measuring method comprising:
outputting the light emission signal to the light source and the exposure signal to the solid-state image sensor;
calculating a first distance to the target object based on the distance detection signals generated by the first pixels; and
calculating a second distance to the target object based on the phase difference detection signals generated by the second pixels, and performing processing for correcting the first distance based on the first distance and the second distance.
